(19) United States
(12) Patent Application Publication
(10) Pub. No.: US 2003/0199796 A1
(43) Pub. Date: Oct. 23, 2003

(54) Portable massaging apparatus

(75) Inventors: Noriyoshi Yamazaki, Fujieda-shi (JP); Takafumi Mito, Fujieda-shi (JP)

Correspondence Address: ARMSTRONG,WESTERMAN & HATTORI, LLP, 1725 K STREET, NW, SUITE 1000, WASHINGTON, DC, 20006, US

(73) Assignee: MARUTAKA CO., LTD, Fujieda-shi (JP)

(21) Appl. No.: 10/266,644

(22) Filed: Oct. 9, 2002

(30) Foreign Application Priority Data
Apr. 18, 2002 (JP) 2002-115694

(51) Int. Cl. A61H 7/00

(52) U.S. Cl. 601/87; 601/95; 601/134

(57) ABSTRACT

The portable massaging apparatus has a pair of driving shafts, 11 and 12, each of which is placed opposite and slant each other so that the distance between center axes of the driving shafts increases along with the distance from the root position to the top position of each driving shaft. A pair of slant shafts, 5 and 6, are extended from the top position of the each driving shaft keeping each angle between the center axis of the slant shaft and the center axis of the driving shaft to an approximately same constant value. A pair of massaging balls, 3 and 4, are attached to the tops of the slant shafts so that each massaging ball rotates freely around the center axis of each slant shaft. A driving mechanism rotates the pair of driving shafts at the same speed in the opposite direction so that each of the slant shafts moves synchronously and mirror symmetrically each other.

### BACKGROUND OF THE INVENTION

This invention is related to a compact size portable massaging apparatus, especially a portable massaging apparatus having a pair of massaging balls that can be used for massaging a specific portion of a human body such as the waist or the neck, by placing the said apparatus on the back of a chair, a legless chair, or a sofa, or by placing it directly on a floor or a mat.

### DESCRIPTION OF THE PRIOR ART

A portable massaging apparatus, in which the rotating force from a driving motor is transmitted to a rotating rod through transmission gears and a massaging ball attached to the top of the rotating arm is rotated according to the rotation of the rod, is known by JP, A, H5-184639. Other portable massaging apparatuses, in which a massaging ball is moved up-and-down at a specific portion of a body in order to generate massaging pressure change, are also known by references such as JP, A, S62-194856, JP, B, 2928469 and JP, B, 323560.

An ideal massaging motion for massaging balls of a portable massaging apparatus is considered as such that can simulate a real motion of massager's hands as close as possible. That is, the ideal motion is rather a three-dimensional one, starting from the opposite two sides of the portion to be massaged, increasing massage pressure as the massaging balls move to the center of the portion, reducing the pressure as the massaging balls move back to the original opposite sides, and finally releasing the portion from massaging.

Conventional massaging apparatuses mentioned above, however, cannot generate such a natural massaging touch as hands of a massager can bring about, since the motion of the massaging balls of conventional portable massaging apparatuses is only two dimensional, rotating simply in a horizontal plane or moving up-and-down to change the massaging pressure.

The purpose of this invention is to solve such problems of the conventional portable massaging apparatuses as mentioned above, and to realize a portable massaging apparatus having a pair of massaging balls that can move more widely in both horizontal and vertical directions, enabling massaging area extension and generating a more natural massaging touch similar to hand massaging.

### SUMMARY OF THE INVENTION

The above mentioned purpose is attained by a portable massaging apparatus comprising: (a) a holding frame (13), (b) a pair of driving shafts (11 and 12) each of which is hold by said holding frame through a bushing in order to rotate freely, and each of which is placed opposite and slant each other on the holding frame so that the distance between center axes of the driving shafts increases along with the distance from the root position to the top position of each driving shaft, (c) a pair of slant shafts (5 and 6) each of which is extended from the top position of said each driving shaft keeping each angle between the center axis of the slant shaft and the center axis of the driving shaft to an approximately same constant value, (d) a pair of massaging balls (3 and 4) that are attached to the tops of said slant shafts so that each massaging ball rotates freely around the center axis of each slant shaft, and (e) a driving mechanism that rotates said pair of driving shafts at the same speed in the opposite direction so that each of said slant shafts moves synchronously and mirror symmetrically each other, wherein each of said massaging balls makes a head rotating motion by rotation of each driving shaft as each slant shaft goes round along the surface of a virtual handstand cone having its peak on the center axis of the corresponding driving shaft.

By this head turning motion of the massaging balls as each slant shaft goes round along the surface of a virtual handstand cone having its peak on the center axis of the corresponding driving shaft, it becomes possible for the pair of massaging balls to move more widely as compared to conventional ones in both horizontal and vertical directions, and thus it becomes possible to obtain a natural massaging touch with alternating strong and soft touches just as similar to those of human massager's.

It is desirable in the portable massaging apparatus of this invention that said driving mechanism contains (p) a pair of worm wheels, (q) a worm that is placed between said pair of worm wheels and is geared with both of the worm wheels and (r) a motor that drives the worm to rotate, wherein said holding frame contains a first portion (13A) that holds one of the said pair of driving shafts through a bushing and the second portion (13B) that holds the other of the said pair of driving shafts, and wherein said first and second portions of the holding frame are connected each other through the worm so that they can move around the center axis of the worm, in order to make the angle between the center axes of said driving shafts variable through this movement.

The best comfortable massaging effect can be obtained by the composition explained above, since the slant angle between the two driving shafts can be adjusted as desired.

### DESCRIPTION OF DRAWINGS

FIG. 1 is a slant view of an embodiment of the portable massaging apparatus of this invention.

FIG. 2 is a partial side view of main components of an embodiment of the portable massaging apparatus of this invention.

FIG. 3 is a partial plane view of main components of the embodiment of the portable massaging apparatus of this invention.

FIG. 4 is a slant view of a massaging ball that is used in the portable massaging apparatus of this invention.

FIG. 5 is a schematic picture to show contours of head turning movement of the massaging balls.

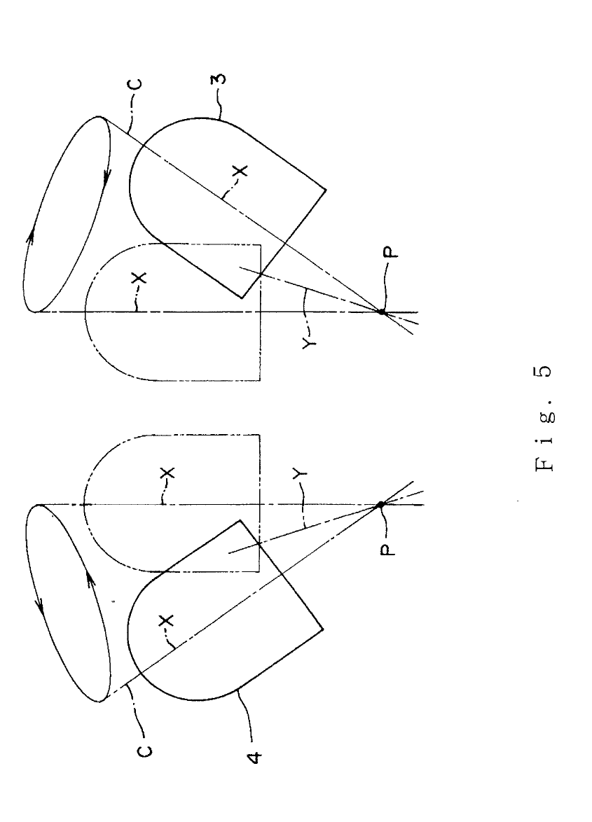

FIG. 6 is a partial side view of main components of another embodiment of the portable massaging apparatus of this invention.

FIG. 7 is a cross section view of a massaging ball of another embodiment of the portable massaging apparatus of this invention.

### DESCRIPTION OF THE PREFERRED EMBODIMENT

The preferred embodiment of the portable massaging apparatus of this invention will be explained hereinafter referring to drawings.

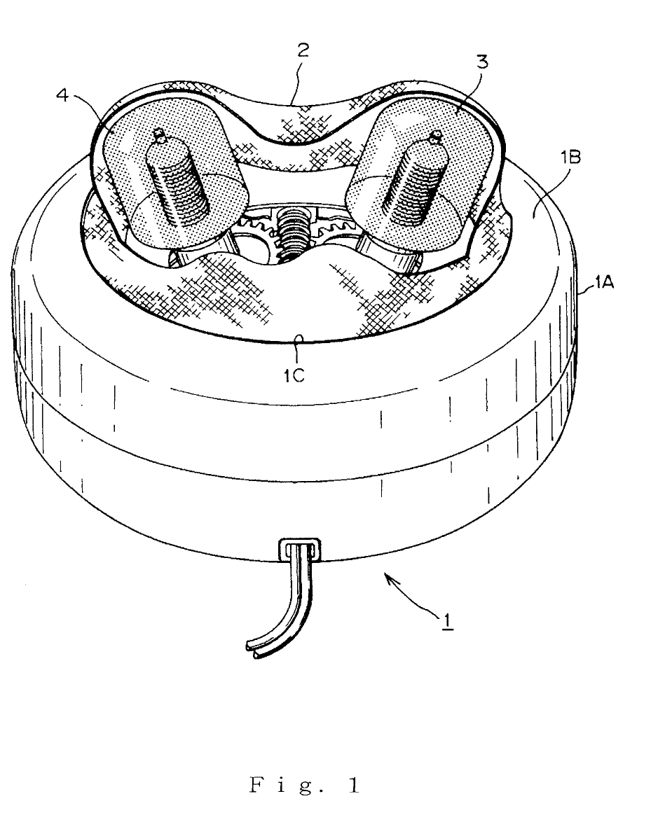

FIG. 1 is a slant view of an embodiment of the portable massaging apparatus of this invention. In this embodiment, the portable massaging apparatus 1 (will be referred as the “massaging apparatus” hereafter) includes a main body 1A, an upper portion 1B, and an aperture 1C that is opened above the upper portion 1B in the shape of an oval. A covering cloth 2 made from flexible polypropylene is attached on the aperture 1C to cover the massaging balls 3 and 4 that project from the aperture.

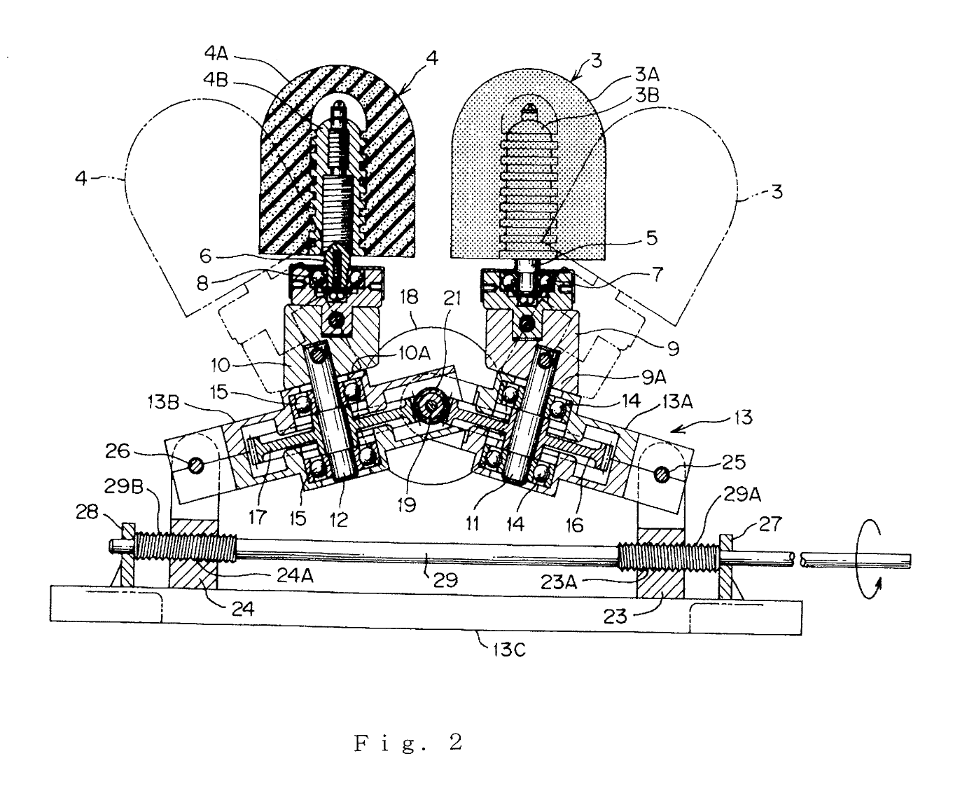

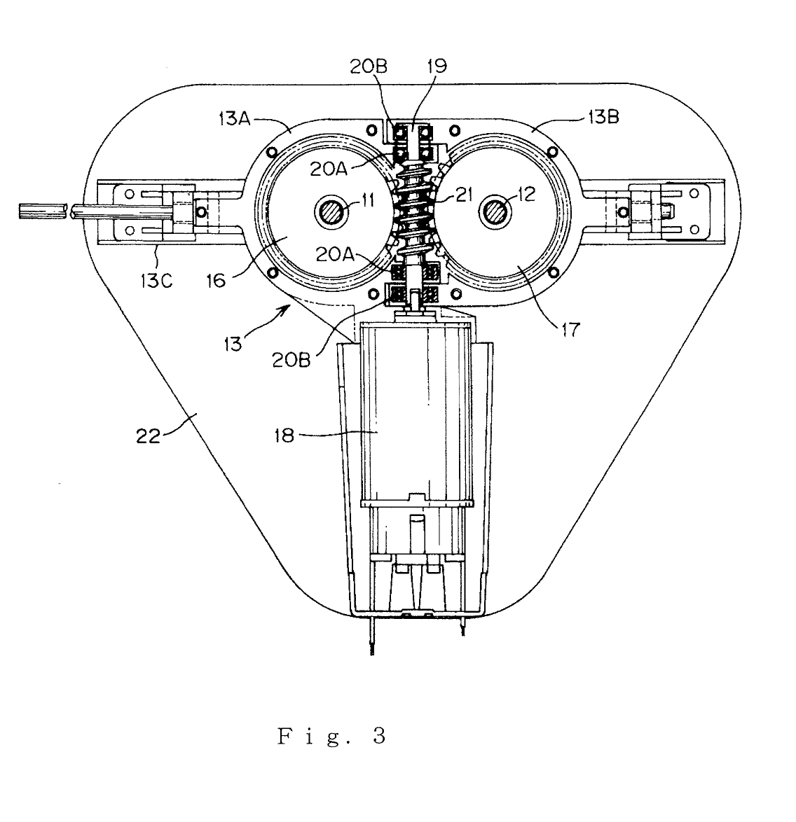

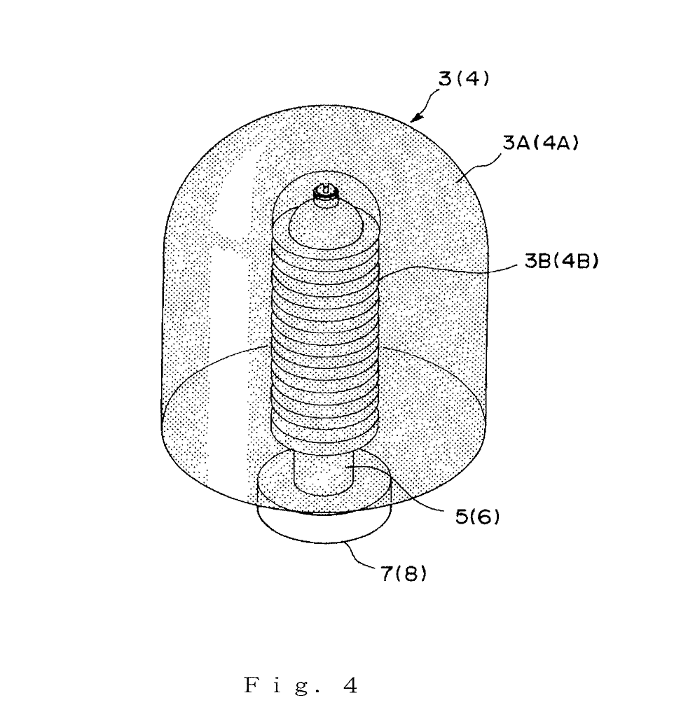

FIG. 2 is a partial side view of main components of the massaging apparatus 1, FIG. 3 is a partial plane view of main components of the massaging apparatus 1, and FIG. 4 is a slant view to show the shape of the massaging ball. As are shown in FIGS. 2 and 4, these massaging balls 3 and 4 are composed of massaging ball main bodies 3A and 4A that have hemisphere shape in the upper portion and cylinder shape in the lower portion, and of sleeves 3B and 4B that are made from hard resin and are inserted and fixed to the central portion of the massaging ball main bodies 3A and 4A.

The massaging ball main bodies 3A and 4A are made from soft and elastic rubber or resin such as polyurethane. The upper ends of slant shafts 5 and 6 project from the massaging apparatus main bodies 1A to the massaging apparatus upper portion 1B through the aperture 1C, and are inserted to the sleeves 3B and 4B and fixed by adhesive, respectively.

The lower end of the slant shafts 5 and 6 are attached to shaft cylinders 9 and 10 through bearings 7 and 8, respectively, so that the slant shafts can rotate freely against the shaft cylinders 8 and 9. The lower end surfaces of the cylinders, 9A and 10A, are slant to the upper end surfaces of the cylinders 9 and 10, respectively, to which the slant shafts 5 and 6 are attached vertically. The driving shafts 11 and 12 are fixed vertically to the lower end surfaces of the cylinders, 9A and 10A, respectively.

These driving shafts 11 and 12 are hold by a first portion, 13A, and a second portion, 13B, of the holding frame 13 through each pair of bearings 14 and 15, respectively, so that these driving shafts can be rotated freely against the holding frame 13.

The first portion, 13A, and the second portion, 13B, of the holding frame 13 are composed as a gear box, within which contained are worm wheels 16 and 17 that are fixed to the driving shafts 11 and 12, respectively.

As are shown in FIG. 3, said first portion 13A and said second portion 13B of the holding frame 13 are connected each other via a worm shaft 19 through each one pair of bearings 20A and 20B, so that the first and the second portions 13A and 13B can move around the worm shaft that is driven to rotate by a motor 18 fixed on the second portion 13B of the holding frame.

A pair of worm wheels 16 and 17 having the same size is fixed to the said worm shaft 19. The worm wheels 16 and 17 rotate synchronously in the opposite directions each other when the motor 18 drives the worm shaft to rotate, since a worm 21 that is geared to both of worm wheels 16 and 17 is fixed to said worm shaft 19.

As shown in FIG. 2, the first portion 13A and the second portion 13B of the holding frame 13 are attached to a third portion 13C of the holding frame 13 that is fixed on a substrate 22 that is placed inside the main body 1A of the massaging apparatus.

In this embodiment of the invention, the first portion 13A and the second portion 13B of the holding frame are connected each other at each one end through the worm shaft as mentioned above, while each far end of the first portion 13A and the second portion 13B of the holding frame is attached to the third portion 13C of the holding frame 13, so that each attached point can move along the longer dimension of the third portion 13C to come nearer to or go farther from each other.

In order to adjust the position of the attached points, the first portion 13A and the second portion 13B of the holding frame are connected to the upper portions of a pair of sliding blocks 23 and 24 through connection shafts 25 and 26 which are in parallel and on the same plane with the worm shaft 19, respectively, where each of the pair of sliding blocks is hold with guidance by the third portion 13C of the holding frame 13 so that it can slide freely.

Screw holes 23A and 24A are made on the sliding blocks 23 and 24, and screw portions 29A and 29B of an adjusting shaft 29 are geared to the screw holes 23A and 23B, respectively, where the adjusting shaft 29 is hold by bearing bridges 27 and 28 that are fixed on the third portion 13C of the holding frame 13 so that it can rotate freely.

The screw directions of the screw portions 29A and 29B are made opposite to each other, so that when the adjusting shaft is turned to one direction the pair of sliding blocks comes nearer to each other, and when the adjustment shaft is turned to the other direction the pair of sliding blocks go further from each other.

When the sliding blocks move to come nearer to each other, the first position 13A and the second position 13B of the holding frame 13 are bent upward around the worm shaft, making the angle between central axes of the driving shafts 11 and 12 increase to the spreading direction.

When the sliding blocks move to go further from each other, the first position 13A and the second position 13B of the holding frame 13 are bent downward to the flat position, making the central axes of the driving shafts 11 and 12 vertical to the third portion 13C of the holding frame 13. Distance between two opposed massaging balls 3 and 4 can be thus varied through the mechanism explained above.

How to use the massaging apparatus 1 described heretofore is explained next. When the massaging apparatus 1 is used for massaging a waist portion, the massaging apparatus 1 is put on a chair, a legless chair or a sofa, leant on a backrest.

A user of the massaging apparatus 1 sits on the chair or the sofa, putting the pair of massaging balls of the massaging apparatus to the user's waist portion to be massaged through the covering cloth 2. If the distance between the pair of massaging balls 3 and 4 is not appropriate, that is, too narrow or too wide, the distance can be adjusted to an appropriate one by moving the adjustment shaft 29.

If the adjustment shaft is formed as its one end is hexagonally shaped to be fit to a tool like a hexagonal wrench, the adjustment shaft can be turned by using the tool inserted through a hole of the main body 1A of the massaging apparatus 1. Or, if the adjustment shaft is formed to project outside the main body 1A and a knob is attached to it, the adjustment shaft can be rotated by turning the knob by hand. Or, the adjustment shaft may be turned by an independent motor.

When the motor 18 is switched on, the worm shaft 19 rotates and worm wheels 16 and 17 that gear with the worm shaft rotate synchronously to the opposite directions. Rotations of the worm wheels 16 and 17 are transmitted to the driving shafts 11 and 12 that are fixed to the worm wheels 16 and 17, respectively, and the shaft cylinders 9 and 10 that are fixed to the driving shafts 11 and 12 rotate accordingly.

The center axes of the slant shafts 5 and 6 that are attached to the shaft cylinders 9 and 10 through bearings 7 and 8 to rotate freely, are made slant so that they cross with the center axes of the driving shafts 11 and 12 at points below the attaching points of the shaft cylinders 9 and 10, respectively, namely at points near the worm wheels 16 and 17, respectively, in this embodiment.

As the driving shafts 11 and 12 rotate, each center axis X of the slant shafts 5 and 6 goes round along the surface of a virtual handstand cone having its peak P on the center axis Y of the corresponding driving shafts 11 and 12, respectively. The massaging balls 3 and 4 that are fixed to the top of the slant shafts 5 and 6 make a head turning motion, accordingly.

Through such a head turning motion explained above, the two massaging balls 3 and 4 are coming nearer to the waist portion to be massaged from initial distant points, placing the waist portion to be massaged in between them and pushing the waist portion from the both sides. When the two massaging balls turn back to the original portions through the head turning motion, they go further from the waist portion to be massaged so that the pushing force is weakened gradually. By repeating this motion continuously, the user can obtain a massaging touch that is similar to the one by massager's hands.

It is possible to add a detecting means to detect the rotation positions of the worm shaft 19 and the driving shafts 11 and 12, and to make the pair of the massaging balls come to the furthest opposite positions when the user stops the motor 18. By doing this, comfort at the beginning and ending of massaging can be further increased.

When the massaging apparatus 1 is used for massaging a neck portion, the massaging apparatus 1 is put on a floor or a mattress. The user of the massaging apparatus lies on his or her back putting the neck portion touched on the pair of the massaging balls 3 and 4 through the covering cloth 2, and then starts the massaging apparatus to work.

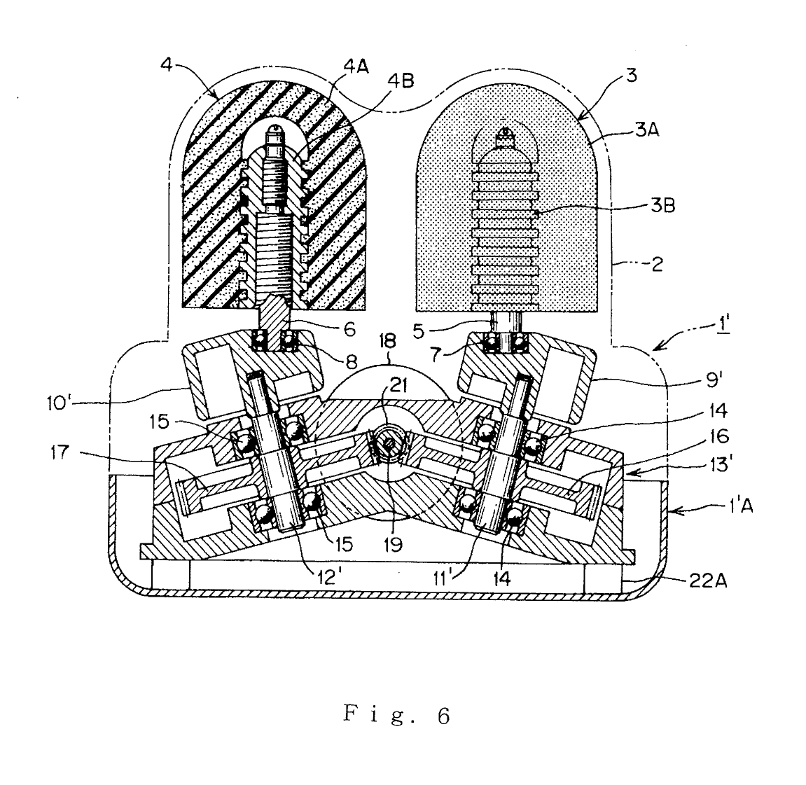

FIG. 6 shows a partial side view of main components of another embodiment of the portable massaging apparatus of this invention. The same numbering for components in FIG. 6 and those in FIG. 2 means that these components are using the same materials.

In the massaging apparatus 1′ of this embodiment, the slant angle between the pair of driving shafts 11′ and 12′ is fixed, and the pair of worm wheels 16 and 17 is contained in a holding frame 13′ that is formed as one unified component.

Also in this embodiment, a shaft of the motor 18 is formed as the worm shaft 19 at the same time, and the worm 21 is fixed directly to the shaft of the motor. The worm 21 can be formed as the outer portion of the worm shaft 19 to be unified as one component.

The holding frame 13′ is directly fixed on the substrate 22A that is placed at the bottom of the main body 1A′. Shaft cylinders 9A and 10A is formed as one component by using resin or die-casting, in order to reduce manufacturing cost as compared to the former embodiment of this invention where the shaft cylinders 9 and 10 are composed of two parts, respectively.

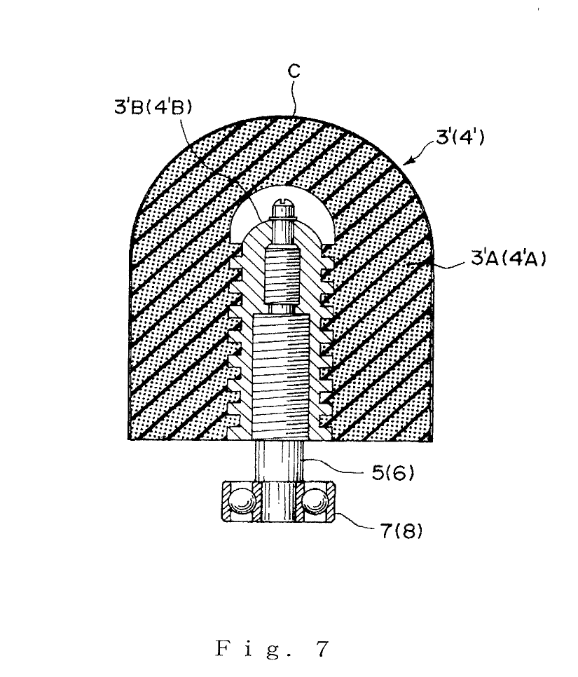

FIG. 7 shows a cross section view of a massaging ball of another embodiment of the portable massaging apparatus of this invention. In the massaging ball 3′ (4′) shown in FIG. 7, massaging ball main body 3′A (4′A) and sleeves 3′B (4′B) are the same as those of massaging balls 3 and 4 in the previous embodiment, respectively, but the outer surface of the massaging balls of this embodiment is coated by a laminate layer C consisting of stuffs that are dirt-resistant, flexible and hard to be worn out or cut, such as poly-amid (for outer coating) and poly-urethane (for inner coating), in order to increase endurance.

Although in each embodiment of the invention explained hereinbefore, the shaft cylinders 9, 10, 9′ and 10′ are attached to the top of the driving shafts 11, 12, 11′ and 12′, respectively, and slant shafts 5 and 6 are hold by these shaft cylinders 9, 10, 9′ and 10′ through bearings 7 and 8, respectively, in order to rotate freely, it is possible to delete shaft cylinders, to compose the driving shaft and the slant shaft as one unified component and to attach the massaging ball to the top of the slant shaft so that it can rotates freely.

Shapes and stuffs of the massaging balls are not limited to the ones shown in the embodiment examples explained heretofore, but can be expanded to various shapes and stuffs that are suitable for massaging waist or neck portions of a human body.

What are claimed are:

1. A portable massaging apparatus comprising:
(a) a holding frame (13);
(b) a pair of driving shafts (11 and 12) each of which is hold by said holding frame through a bushing in order to rotate freely, and each of which is placed opposite and slant each other on the holding frame so that the distance between center axes of the driving shafts increases along with the distance from the root position to the top position of each driving shaft;
(c) a pair of slant shafts (5 and 6) each of which is extended from the top position of said each driving shaft keeping each angle between the center axis of the slant shaft and the center axis of the driving shaft to an approximately same constant value;
(d) a pair of massaging balls (3 and 4) that are attached to the tops of said slant shafts so that each massaging ball rotates freely around the center axis of each slant shaft; and
(e) a driving mechanism that rotates said pair of driving shafts at the same speed in the opposite direction so that each of said slant shafts moves synchronously and mirror symmetrically each other, wherein each of said massaging balls makes a head turning motion by rotation of each driving shaft as each slant shaft goes round along the surface of a virtual handstand cone having its peak on the center axis of the corresponding driving shaft.

2. A portable massaging apparatus claimed in claim 1, wherein said driving mechanism contains:
(p) a pair of worm wheels;
(q) a worm that is placed between said pair of worm wheels and is geared with both of the worm wheels; and
(r) a motor that drives the worm to rotate,
wherein said holding frame contains a first portion (13A) that holds one of the said pair of driving shafts through a bushing and the second portion (13B) that holds the other of the said pair of driving shafts, and
wherein said first and second portions of the holding frame are connected each other through the worm so that they can move around the center axis of the worm, in order to make the angle between the center axes of said driving shafts variable through this movement.
